(19) United States
(12) Patent Application Publication
(10) Pub. No.: US 2025/0175606 A1
(43) Pub. Date: May 29, 2025

(54) VIDEO ENCODER

(71) Applicant: SigmaStar Technology Ltd., Xiamen (CN)

(72) Inventors: WEI MIN ZENG, Shanghai (CN); CHENG HUNG TSAI, Xiamen (CN)

(21) Appl. No.: 18/934,286

(22) Filed: Nov. 1, 2024

(30) Foreign Application Priority Data
Nov. 24, 2023 (CN) 202311597398.7

(51) Int. Cl. H04N 19/13; H04N 19/176; H04N 19/423; H04N 19/91

(52) U.S. Cl. CPC H04N 19/13; H04N 19/176; H04N 19/423; H04N 19/91

(57) ABSTRACT

A video encoder is coupled to an external memory and configured to encode an input data to generate an output data. The input data includes a coding block. The video encoder includes a control circuit, a data loading circuit, a mode decision circuit, and an entropy coding circuit. The control circuit generates a start signal corresponding to the coding block. The data loading circuit reads the coding block from the external memory according to the start signal. The mode decision circuit processes the coding block according to the starting signal and generate an intermediate data. The entropy coding circuit generates the output data according to the intermediate data. In a video encoding mode, the control circuit further generates an indication signal indicating whether an image block of the coding block exists, and the mode decision circuit processes the image block according to the indication signal.

This application claims the benefit of China application Serial No. 202311597398.7, filed on Nov. 24, 2023, the subject matter of which is incorporated herein by reference.

### BACKGROUND OF THE INVENTION

### 1. Field of the Invention

The present invention generally relates to video encoding/decoding, and, more particularly, to a video encoder.

### 2. Description of Related Art

There are three common video encoding/decoding methods: H.264 (i.e., MPEG-4 Part 10, Advanced Video Coding, abbreviated as MPEG-4 AVC), H.265 (i.e., High Efficiency Video Coding, abbreviated as HEVC), and AV1 (i.e., Alliance for Open Media (AOMedia) Video 1, AOMedia Video 1). Because these three methods have their respective specifications, it is not easy to integrate any two or all three of them into a single video codec, which increases the cost of the end product.

### SUMMARY OF THE INVENTION

In view of the issues of the prior art, an object of the present invention is to provide a video encoder and a control method thereof, so as to make an improvement to the prior art.

According to one aspect of the present invention, a video encoder is provided. The video encoder is coupled to an external memory and configured to encode an input data to generate an output data. The input data includes a coding block. The video encoder includes a control circuit, a data loading circuit, a mode decision circuit, and an entropy coding circuit. The control circuit is configured to generate a start signal corresponding to the coding block. The data loading circuit is coupled to the control circuit and configured to read the coding block from the external memory according to the start signal. The mode decision circuit is coupled to the control circuit and configured to process the coding block according to the start signal and generate an intermediate data. The entropy coding circuit is coupled to the mode decision circuit and configured to generate the output data according to the intermediate data. In a video encoding mode, the control circuit further generates an indication signal indicating whether an image block of the coding block exists, and the mode decision circuit processes the image block according to the indication signal.

According to another aspect of the present invention, a video encoder is provided. The video encoder is coupled to an external memory and configured to encode an input data to generate an output data. The input data includes a first to-be-processed block and a second to-be-processed block. The video encoder includes a control circuit, a data loading circuit, a mode decision circuit, and an entropy coding circuit. The control circuit is configured to generate a first start signal corresponding to the first to-be-processed block and a second start signal corresponding to the second to-be-processed block. The data loading circuit is coupled to the control circuit and configured to read the first to-be-processed block from the external memory according to the first start signal and read the second to-be-processed block from the external memory according to the second start signal. The mode decision circuit is coupled to the control circuit and configured to process the first to-be-processed block according to the first start signal, process the second to-be-processed block according to the second start signal, and generate an intermediate data. The entropy coding circuit is coupled to the mode decision circuit and configured to generate the output data according to the intermediate data. The first to-be-processed block is adjacent to the second to-be-processed block. In a video encoding mode, the control circuit generates the second start signal before the mode decision circuit finishes processing the first to-be-processed block.

According to still another aspect of the present invention, a video encoder is provided. The video encoder is coupled to an external memory and configured to encode an input data to generate an output data. The input data includes a first block and a second block, and the first block is adjacent to the second block. The video encoder includes a control circuit, a data loading circuit, a mode decision circuit, and an entropy coding circuit. The control circuit is configured to generate a first start signal corresponding to the first block and a second start signal corresponding to the second block. The data loading circuit is coupled to the control circuit and configured to read the first block from the external memory according to the first start signal and read the second block from the external memory according to the second start signal. The mode decision circuit is coupled to the control circuit and configured to process the first block according to the first start signal, process the second block according to the second start signal, and generate an intermediate data. The entropy coding circuit is coupled to the mode decision circuit and configured to generate the output data according to the intermediate data. In a first video encoding mode, the control circuit generates the second start signal after the mode decision circuit finishes processing the first block. In a second video encoding mode, the control circuit generates the second start signal before the mode decision circuit finishes processing the first block. The first block and the second block are both N by N pixels in size, and N is four or an integer multiple of four.

The technical means embodied in the embodiments of the present invention can solve at least one of the problems of the prior art. Therefore, compared to the prior art, the present invention can share hardware to save cost.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of a video encoder according to an embodiment of the present invention.

FIG. 2 is a schematic diagram of the internal control signals of the video encoder of the present invention.

FIG. 3 is a functional block diagram of the control circuit according to an embodiment of the present invention.

FIG. 4 is a schematic diagram of multiple image blocks and multiple control signals in the first video encoding mode according to an embodiment of the present invention.

FIGS. 5A and 5B are the flowcharts illustrating the generation of start signals by the control circuit in the first video encoding mode.

FIGS. 6A to 6C are the flowcharts illustrating the generation of end signals by the mode decision circuit according to start signals in the first video encoding mode.

FIG. 7 is a schematic diagram of multiple image blocks and multiple control signals in the second video encoding mode according to an embodiment of the present invention.

FIGS. 8A to 8B are the flowcharts illustrating the generation of start signals by the control circuit in the second video encoding mode;

FIG. 9 is a schematic diagram of multiple image blocks in the second video encoding mode according to another embodiment of the present invention.

FIG. 10 is a flowchart illustrating the generation of end signals by the mode decision circuit according to start signals in the second video encoding mode.

FIG. 11 is a functional block diagram of the mode prediction circuit of the mode decision circuit according to the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a video encoder and a control method thereof. On account of that some or all elements of the video encoder could be known, the detail of such elements is omitted provided that such detail has little to do with the features of this disclosure, and that this omission nowhere dissatisfies the specification and enablement requirements.

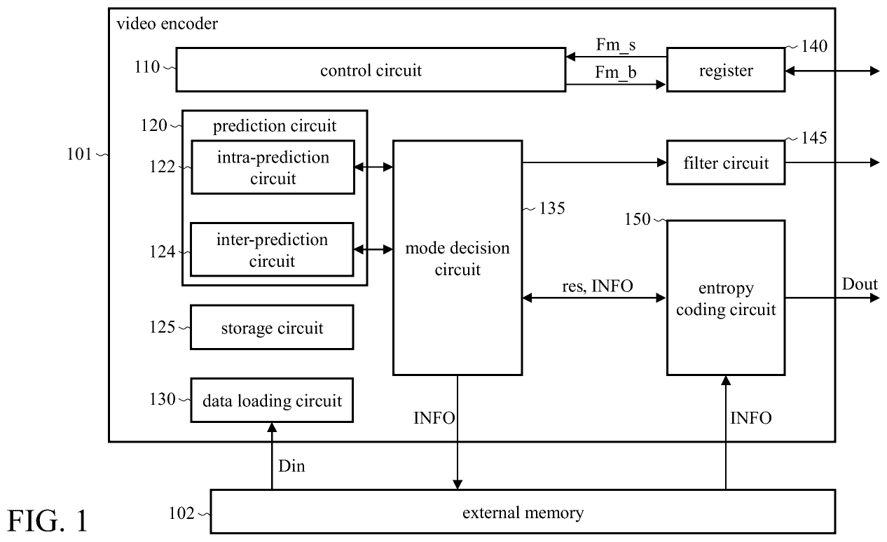

FIG. 1 is a functional block diagram of a video encoder according to an embodiment of the present invention. The video encoder 101 is coupled to an external memory 102 and includes a control circuit 110, a prediction circuit 120, a storage circuit 125, a data loading circuit 130, a mode decision circuit 135, a register 140, a filter circuit 145, and an entropy coding circuit 150. The prediction circuit 120 includes an intra-prediction circuit 122 and an inter-prediction circuit 124. The storage circuit 125 may be a line buffer. The external memory 102 may be a dynamic random access memory (DRAM).

The control circuit 110 is used to control the encoding process of the video encoder 101. More specifically, the control circuit 110 controls other components to start and/or end operations at appropriate times according to the video encoding mode of the video encoder 101. For example, when the video encoder 101 starts to encode a coding block (e.g., an image block of N by N pixels (hereinafter referred to as “N×N,” where N is four or an integer multiple of four)), the control circuit 110 controls the intra-prediction circuit 122, the inter-prediction circuit 124, the storage circuit 125, the data loading circuit 130, the mode decision circuit 135, and the filter circuit 145 to clear or reset data (e.g., register values).

The register 140 is coupled to a processing unit (not shown) and configured to store the frame start signal Fm_s transmitted by the processing unit to the video encoder 101. The frame start signal Fm_s indicates the beginning of a frame. When the video encoder 101 is processing a frame, the control circuit 110 writes a busy signal Fm_b in the register 140 to indicate that the video encoder 101 is performing encoding.

The data loading circuit 130 is used to load a subset of the input data Din (e.g., one or more frames of video data) and/or reference data required for encoding (e.g., the encoding result of a previous frame or a previous image block) from the external memory 102.

The storage circuit 125 is used to store and manage the data of the coding blocks in a previous row.

The intra-prediction circuit 122 and the inter-prediction circuit 124 perform intra-prediction and inter-prediction on an image block respectively, to generate the intra-prediction image and the inter-prediction image respectively. The inter-prediction circuit 124 further generates prediction information based on motion estimation.

The mode decision circuit 135 performs the following operations: subtracting the prediction image (the intra-prediction image or inter-prediction image) from the original image to generate an image difference; performing transformation and quantization operations on the image difference to obtain the residual res; and performing inverse quantization and inverse transformation operations on the residual res to obtain an intermediate result, and then adding the intermediate result to the prediction image to generate a reconstruction image. The mode decision circuit 135 further performs a full rate-distortion optimization (RDO) operation based on the intermediate result and a rate table to generate an intermediate data INFO. The intermediate data INFO includes, but is not limited to, the block coding method of the image blocks. The block coding method determines how to divide the image blocks (i.e., whether to encode using larger or smaller blocks) and whether to use intra-prediction image or inter-prediction image for encoding.

The filter circuit 145 is coupled to the mode decision circuit 135 and configured to filter the reconstruction image to generate a filtered image.

The entropy coding circuit 150 is coupled to the mode decision circuit 135 and configured to perform entropy coding based on the residual res and the intermediate data INFO to obtain the output data Dout (e.g., bit stream).

Since the method for generating the intermediate data INFO, the filtering operation, and the entropy coding operation are well known to those skilled in the art, detailed descriptions thereof are omitted for brevity.

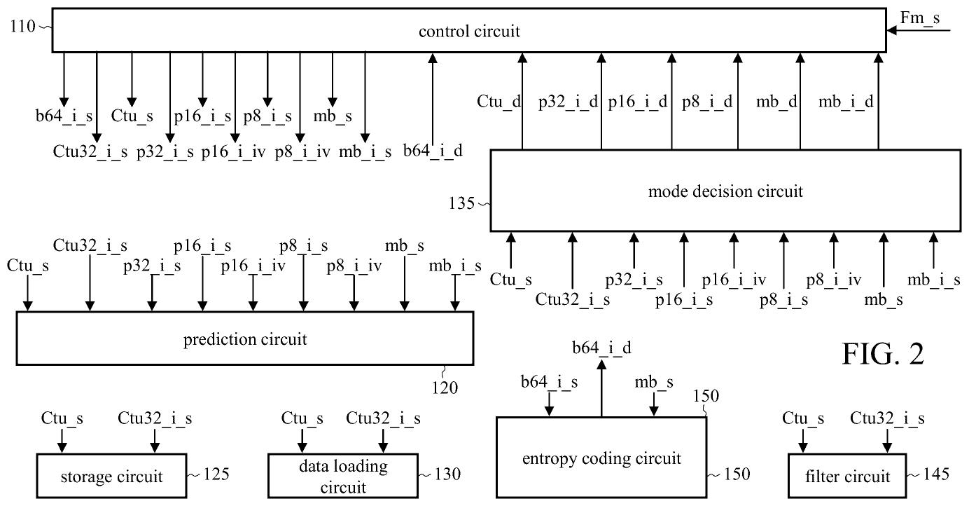

FIG. 2 is a schematic diagram of the internal control signals of the video encoder according to the present invention. The control circuit 110 generates the start signals (including the start signals b64_i_s, Ctu_s, Ctu32_i_s, p32_i_s, p16_i_s, p8_i_s, mb_i_s, and mb_s) according to the frame start signal Fm_s and the end signals (including the end signals Ctu_d, p32_i_d, p16_i_d, p8i_d, mb_i_d, and mb_d) returned by the mode decision circuit 135, where i is an integer greater than or equal to 0. The start signal b64_i_s corresponds to a 64×64 image block. The start signal Ctu_s, the end signal Ctu_d, the start signal Ctu32_i_s, the start signal p32_i_s, and the end signal p32i_d correspond to a 32×32 image block. The start signal p16_i_s, the end signal p16i_d, the start signal mb_i_s, the end signal mb_i_d, the start signal mb_s, and the end signal mb_d correspond to a 16×16 image block. The start signal p8_i_s and the end signal p8_i_d correspond to an 8×8 image block.

Through the end signals, the mode decision circuit 135 notifies the control circuit 110 that the mode decision circuit 135 has finished processing the corresponding image block (e.g., having generated the intermediate data INFO of that image block).

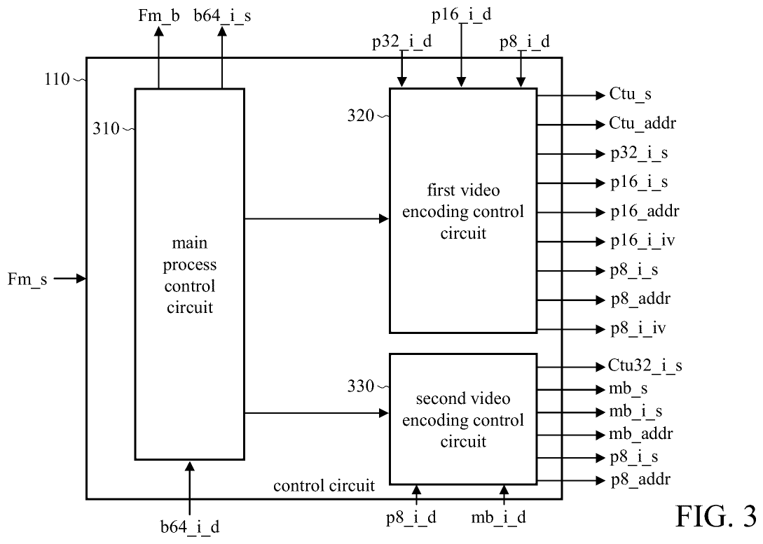

Reference is made to FIG. 3, which is a functional block diagram of the control circuit according to an embodiment of the present invention. The control circuit 110 includes a main process control circuit 310, a first video encoding control circuit 320, and a second video encoding control circuit 330.

The main process control circuit 310 generates the busy signal Fm_b according to the frame start signal Fm_s and generates a start signal b64_i_s for the next superblock according to the end signal b64_i_d of the current to-be-processed block (i.e., a superblock). The end signal b64_i_d is generated by the entropy coding circuit 150 when completing the coding of the current superblock. The main process control circuit 310 can generate a start signal (i.e., the start signal b64_0_s) for the first superblock of a frame according to the frame start signal Fm_s.

The first video encoding control circuit 320 generates the start signal Ctu_s, the address Ctu_addr of the coding block, the start signal p32_i_s, the start signal p16_i_s of a 16×16 image block, the address p16_addr, and the indication signal p16_i_iv, as well as the start signal p8_i_s of an 8×8 image block, the address p8_addr, and the indication signal p8_i_iv according to the frame start signal Fm_s, the end signal p32_i_d, the end signal p16i_d, and the end signal p8_i_d. In some embodiments, the size of a coding block is 32×32; therefore, the address Ctu_addr of a coding block is the address of a 32×32 image block (the coding block p32_i).

The second video encoding control circuit 330 generates the start signal Ctu32_i_s, the start signal mb_s, and an address mb_addr for a macro block, the start signal mb_i_s for the coding block mb_i, and the start signal p8_i_s and address p8_addr for the image block p8_i according to the frame start signal Fm_s, the end signal p8i_d, and the end signal mb_d.

In some embodiments, the above address can be an absolute address (a location in a frame) or a relative address (a location in a larger block).

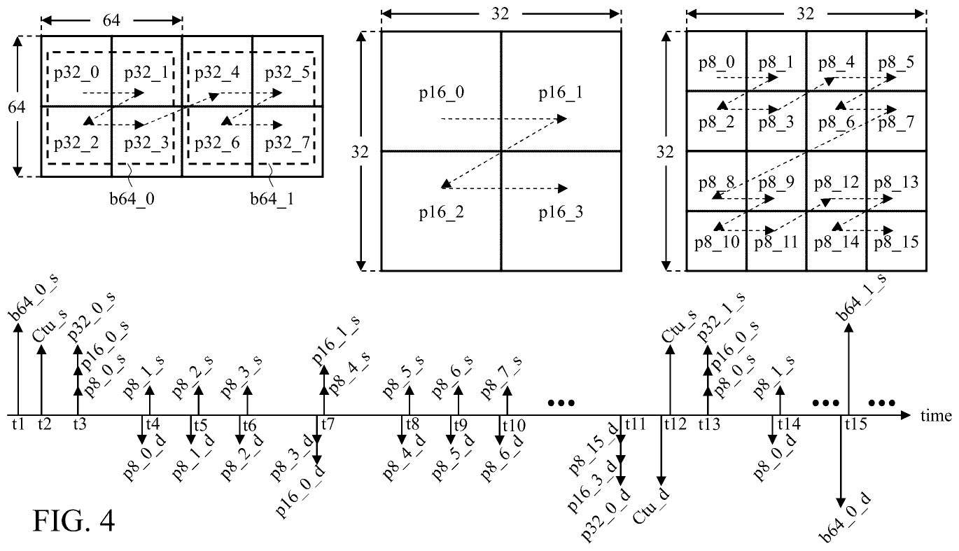

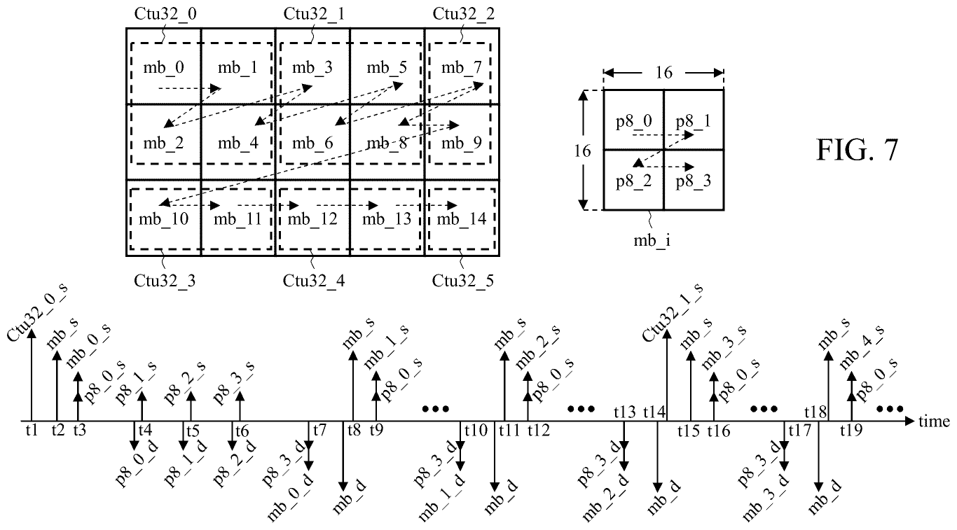

The video encoder 101 can operate in the first video encoding mode (HEVC or AV1) or the second video encoding mode (MPEG-4 AVC). The generation time point and usage of each control signal in the first video encoding mode are discussed with reference to FIG. 4 to FIG. 6C, and the generation time point and usage of each control signal in the second video encoding mode are discussed with reference to FIG. 7 to FIG. 10.

Reference is made to FIG. 4, which is a schematic diagram of multiple image blocks and multiple control signals in the first video encoding mode according to an embodiment of the present invention. The to-be-processed block b64_0 and the to-be-processed block b64_1 are two adjacent superblocks in a frame. The start signals of the to-be-processed blocks b64_0 and b64_1 are the start signals b64_0_s and b64_1_s, respectively. A superblock includes four 32×32 coding blocks. More specifically, the to-be-processed block b64_0 includes the coding blocks p32_0, p32_1, p32_2, and p32_3, and the to-be-processed block b64_1 includes the coding blocks p32_4, p32_5, p32_6, and p32_7.

The video encoder 101 first processes the to-be-processed block b64_0, followed by the to-be-processed block b64_1, and processes the coding blocks within each superblock in a “Z-order curve” sequence (i.e., from lower to higher numbers as indicated by the dashed arrows). In the first video encoding mode, the video encoder 101 reads a coding block from the external memory 102 each time, and then performs encoding in units of one coding block. The video encoder 101 does not encode the superblocks.

In some embodiments, the coding blocks p32_5 and p32_7, as well as the image blocks p16_1, p163, p8_5, p8_7, p8_13, and p8_15 are the rightmost blocks of a frame (i.e., these blocks are located at the right boundary of the frame). FIG. 4 only shows 2 superblocks, in other embodiments, a frame may include more superblocks.

Continuing with FIG. 4, a 32×32 coding block includes 4 16×16 image blocks: p16_0, p16_1, p16_2, and p16_3, or 16 8×8 image blocks: p8_0, p8_1, p8_2, p8_3, p8_4, p8_5, p8_6, p8_7, p8_8, p8_9, p8_10, p8_11, p8_12, p8_13, p8_14, and p8_15.

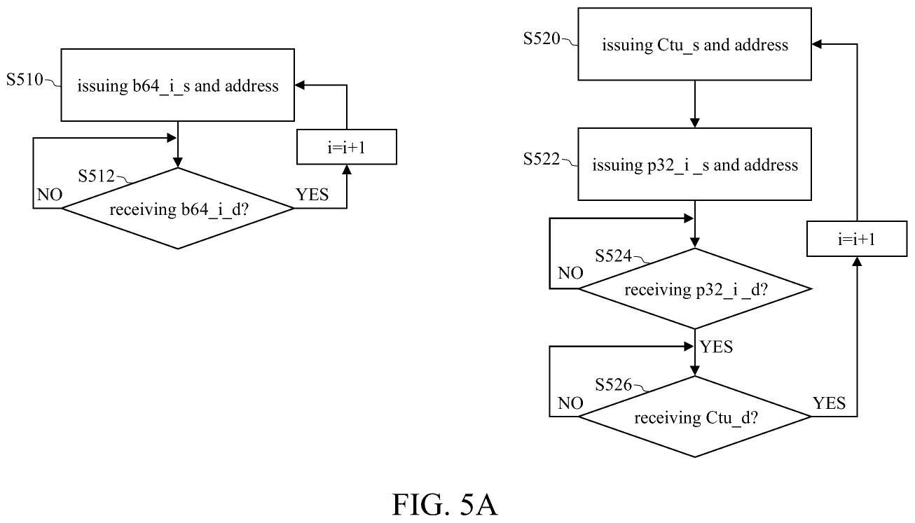

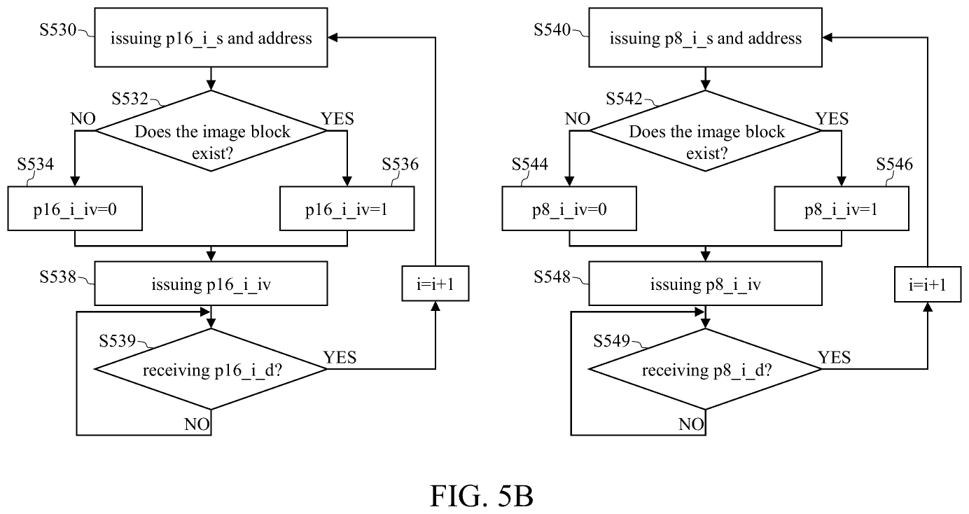

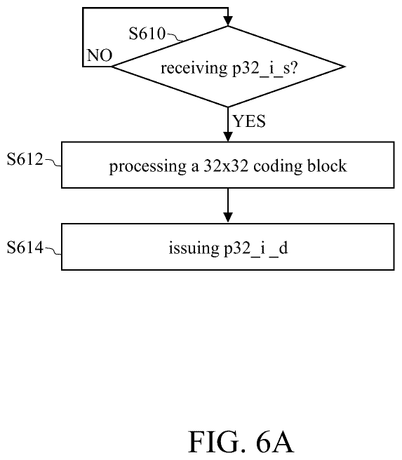

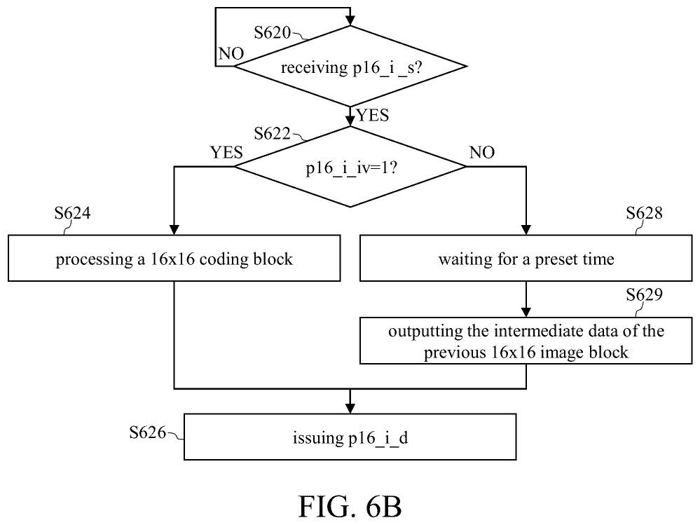

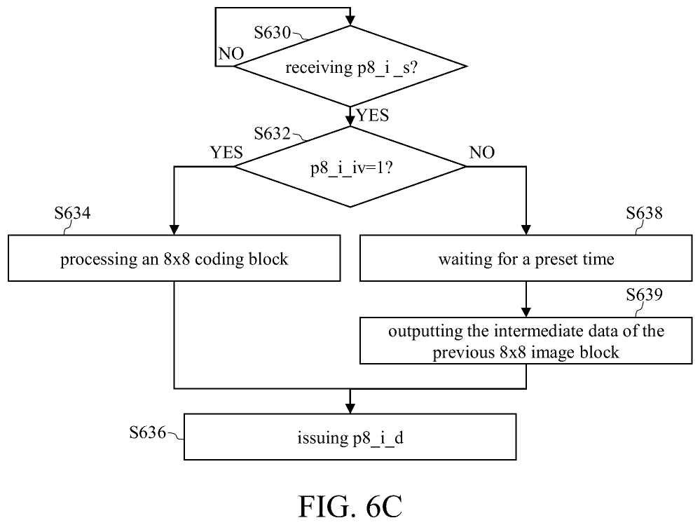

The lower half of FIG. 4 shows the relative generation time of multiple start signals (indicated by upward arrows, with “_s” as a suffix) and multiple end signals (indicated by downward arrows, with “_d” as a suffix). The following discussion is made with reference to FIGS. 5A and 5B and FIGS. 6A to 6C.

FIGS. 5A and 5B are flowcharts illustrating the generation of start signals by the control circuit 110 in the first video encoding mode. That is, FIGS. 5A and 5B show the control method of the video encoder 101, which includes the following steps.

Step S510: The control circuit 110 issues the start signal b64_i_s of the to-be-processed block b64_i and the address of the to-be-processed block b64_i. For example, as shown in FIG. 4, this step may correspond to the start signal b64_0_s of the to-be-processed block b64_0 (at the time point t1). After receiving the start signal b64_i_s of the to-be-processed block b64_i, the entropy coding circuit 150 performs the preprocessing task(s) for encoding the to-be-processed block b64_i (including, but not limited to, resetting parameters and/or registers).

Step S512: The control circuit 110 determines whether the end signal b64_i_d of the to-be-processed block b64_i is received. If NO, then the control circuit 110 continues to wait; if YES (e.g., the reception of the end signal b64_0_d of the to-be-processed block b64_0 around the time point t15 in FIG. 4), then the control circuit 110 issues the start signal of the next to-be-processed block (e.g., the start signal b64_1_s of the to-be-processed block b64_1).

Step S520: The control circuit 110 issues the start signal Ctu_s of the coding block and the address of the coding block. For example, as shown in FIG. 4, this step may correspond to the start signal Ctu_s at the time point t2. As shown in FIG. 4, the start signal Ctu_s is earlier than the start signal p32_i_s of the corresponding coding block p32_i and is used for indicating that the encoding of a coding block is about to start. The prediction circuit 120, the storage circuit 125, the mode decision circuit 135, and the filter circuit 145 perform the preprocessing task(s) for encoding a coding block (including, but not limited to, resetting parameters and/or registers) after receiving the start signal Ctu_s. After receiving the start signal Ctu_s, the data loading circuit 130 reads the corresponding data from the external memory 102 according to the address of the coding block.

Step S522: The control circuit 110 issues the start signal p32_i_s and the address of the coding block p32_i. For example, as shown in FIG. 4, this step may correspond to the start signal p32_0_s at the time point t3. The prediction circuit 120 and the mode decision circuit 135 start to process the coding block p32_0 respectively after receiving the start signal p32_0_s.

Step S524: The control circuit 110 determines whether the end signal p32_i_d of the coding block is received. If NO, then the control circuit 110 continues to wait; if YES (e.g., the reception of the end signal p32_0_d of the coding block p32_0 around the time point t11 in FIG. 4), then the flow proceeds to step S526.

Step S526: The control circuit 110 determines whether the end signal Ctu_d of the coding block is received. If NO, then the control circuit 110 continues to wait; if YES (e.g., the reception of the end signal Ctu_d of the current coding block around the time point t12 in FIG. 4), the control circuit 110 issues the start signal Ctu_s of the next coding block. The end signal Ctu_d is used for indicating that the related components have finished processing the current coding block (including, but not limited to, transmitting the results or temporary data to a subsequent circuit, or storing same in the external memory 102).

As indicated by steps S520 to S526, the control circuit 110 issues the start signal p32_i+1_s of the coding block p32_i+1 only after the mode decision circuit 135 finishes processing the coding block p32_i.

Reference is made to FIG. 5B.

Step S530: The control circuit 110 issues the start signal p16_i_s of a 16×16 image block and the address p16_addr of that image block. For example, as shown in FIG. 4, this step may correspond to the start signal p16_0_s (at the time point t3 or time point t13) of the image block p16_0.

Step S532: The control circuit 110 determines whether the image block exists. More specifically, since the coding blocks in this invention are 32×32, and a frame's width may not always be a multiple of 32, the coding blocks at the rightmost or bottom of a frame might sometimes lack 16×16 or 8×8 image block(s). For example, as shown in FIG. 4, when a frame has a width of 112 pixels (=32×3+16), the coding blocks at the rightmost of the frame (i.e., the coding block p32_5 and the coding block p32_7) do not include the image blocks p16_1, p16_3, p8_4, p8_5, p8_6, p8_7, p8_12, p8_13, p8_14, and p8_15. These image blocks are considered missing or absent by the control circuit 110, as the corresponding original pixels cannot be retrieved from the frame. For another example, when a frame has a width of 120 pixels (=32×3+24), the rightmost coding blocks (i.e., the coding blocks p32_5 and p32_7) do not include the image blocks p16_1, p16_3, p8_5, p8_7, p8_13, and p8_15. The control circuit 110 can determine whether an image block exists according to the size of the frame, the size of the coding block, and the address.

Continuing the previous paragraph, when the image block is absent, the control circuit 110 sets the indication signal p16_i_iv to a first preset value (e.g., 0) (step S534); when the image block exists, the control circuit 110 sets the indication signal p16_i_iv to a second preset value (e.g., 1) (step S536).

Step S538: The control circuit 110 issues the indication signal p16_i_iv.

Step S539: The control circuit 110 determines whether the end signal p16_i_d of the image block is received. If NO, then the control circuit 110 continues to wait; if YES (e.g., the reception of the end signal p16_0_d of the image block p16_0 around the time point t7 in FIG. 4), the control circuit 110 issues the start signal p16_i_s and address of the next 16×16 image block (e.g., the start signal p16_1_s).

Steps S540, S542, S544, S546, S548, and S549 refer to 8×8 image blocks and correspond to steps S530, S532, S534, S536, S538, and S539, respectively. For the sake of brevity, repeated discussion is omitted here.

FIGS. 6A to 6C are flowcharts illustrating the generation of end signals by the mode decision circuit 135 according to the start signals in the first video encoding mode. The flowcharts include the following steps.

Reference is made to FIG. 6A. The mode decision circuit 135 determines whether the start signal p32_i_s of a coding block is received (step S610). If NO, the mode decision circuit 135 continues to wait; if YES (e.g., the reception of the start signal p32_0_s of the coding block p32_0 around the time point t3 in FIG. 4), the mode decision circuit 135 processes the coding block (step S612) and then issues the end signal p32_i_d upon completion (step S614, for example, the issuing of the end signal p32_0_d around the time point t11 in FIG. 4).

Reference is made to FIG. 6B. The mode decision circuit 135 determines whether the start signal p16_i_s of the 16×16 image block is received (step S620). If NO, the mode decision circuit 135 continues to wait; if YES (e.g., the reception of the start signal p16_0_s of the image block p16_0 around the time point t3 in FIG. 4), the mode decision circuit 135 determines whether the image block exists (step S622) (i.e., determining whether the indication signal p16_i_iv is the second preset value). If YES, the mode decision circuit 135 processes the image block to generate the intermediate data INFO of the image block (step S624) and issues the end signal p16_i_d upon completion (step S626, for example, the issuing of the end signal p16_0_d around the time point t7 in FIG. 4); if NO, the mode decision circuit 135 waits for the preset time (step S628) and then outputs the intermediate data INFO of the previous 16×16 image block (step S629, that is, the intermediate data INFO of the previous image block is used as the intermediate data INFO of that image block). That is to say, the mode decision circuit 135 processes the 16×16 image block according to the indication signal p16_i_iv.

Continuing the previous paragraph, for example, as shown in FIG. 4, when the indication signal p16_1_iv (or p16_3_iv) of the image block p16_1 (or p16_3) is 0, the mode decision circuit 135 outputs the intermediate data INFO of the image block p16_0 (or p16_2) in step S629.

Steps S630, S632, S634, S636, S638, and S639 in FIG. 6C refer to 8×8 image blocks and correspond to steps S620, S622, S624, S626, S628, and S629 in FIG. 6B, respectively. For the sake of brevity, repeated discussion is omitted here. Similarly, the mode decision circuit 135 processes the 8×8 image blocks according to the indication signal p8_i_iv.

With respect to step S639, for example, as shown in FIG. 4, when the indication signal p8_5_iv (p8_7_iv, p8_13_iv, or p8_15_iv) of the image block p8_5 (p8_7, p8_13, or p8_15) is 0, the mode decision circuit 135 outputs the intermediate data INFO of the image block p8_4 (p8_6, p8_12, or p8_14) in step S639.

The mode decision circuit 135 and other circuits process the image blocks of each layer (32×32, 16×16, 8×8) according to the control signals generated by the control circuit 110. In some embodiments, people having ordinary skill in the art may implement the control circuit 110 with a finite state machine based on the flowcharts of FIGS. 5A-5B and the timing of FIG. 4 and implement the mode decision circuit 135 with a finite state machine based on the flowcharts of FIGS. 6A-6C and the timing of FIG. 4.

Reference is made to FIG. 7, which is a schematic diagram of multiple image blocks and multiple control signals in the second video encoding mode according to an embodiment of the present invention. In the example of FIG. 7, it is assumed that a frame includes six to-be-processed blocks: Ctu32_0, Ctu32_1, Ctu32_2, Ctu32_3, Ctu32_4, and Ctu32_5, wherein the to-be-processed blocks Ctu32_0 and Ctu32_1 are 32×32 in size, the to-be-processed block Ctu32_2_i_s 16×32 in size, the to-be-processed blocks Ctu32_3 and Ctu32_4 are 32×16 in size, and the to-be-processed block Ctu32_5_i_s 16×16 in size. Each 16×16 coding block mb_i (i is an integer greater than or equal to 0) includes 4 8×8 image blocks: p8_0, p8_1, p8_2, and p8_3.

In the second video encoding mode, the video encoder 101 reads a to-be-processed block from the external memory 102 each time and then performs encoding in units of one coding block mb_i. For example, as shown in FIG. 7, the control circuit 110 uses the start signal Ctu32_j_s (j=0 to 5, corresponding respectively to the to-be-processed blocks Ctu32_0 to Ctu32_5) to control the data loading circuit 130 to read the six to-be-processed blocks in sequence (from lower to higher numbers) from the external memory 102. In one coding block mb_i, the mode decision circuit 135 processes the four 8×8 image blocks in a “Z-order curve” sequence (i.e., from lower to higher numbers as indicated by the dashed arrows).

It should be noted that since the size of the coding block mb_i in the second video encoding mode is 16×16 (instead of 32×32 in the first video encoding mode), there is no (or no need to process) missing or absent image blocks in the second video encoding mode. Furthermore, although the size of the coding block mb_i in the second video encoding mode is 16×16, the control circuit 110 issues a start signal (Ctu32_i_s) for the image block from an upper layer (32×32). That is to say, the control logic of the control circuit 110 remains consistent across the two video encoding modes, facilitating easier switching and component sharing of the video encoder 101 between the two video encoding modes.

It should be noted that, unlike the first video encoding mode, in the second video encoding mode, for a 32×32 to-be-processed block (e.g., Ctu32_0 or Ctu32_1), the mode decision circuit 135 does not process the four 16×16 coding blocks thereof in a “Z-order curve” sequence (i.e., the mode decision circuit 135 does not process the coding blocks in this order: mb_0, mb_1, mb_2, mb_4, or in this order: mb_3, mb_5, mb_6, mb_8); instead, the mode decision circuit 135 processes them according to the order of the coding block numbers (i.e., mb_0, mb_1, mb_2, mb_3, mb_4, mb_5, mb_6, mb_7, mb_8, mb_9, mb_10, mb_11, mb_12, mb_13, mb_14). The reason is that, when processing the coding block mb_4 (or mb_8) in the second video encoding mode, the mode decision circuit 135 must refer to the result of the upper right coding block mb_3 (or mb_7).

Continuing the previous paragraph, it should be noted that in the second video encoding mode, the entropy coding circuit 150 processes the coding blocks mb_i in a row-major order (from left to right and from top to bottom), i.e., in the following order: mb_0, mb_1, mb_3, mb_5, mb_7, mb_2, mb_4, mb_6, mb_8, mb_9, mb_10, . . . Therefore, the mode decision circuit 135 temporarily stores the intermediate data INFO of some coding blocks mb_i (e.g., mb_2, mb_4, mb_6, mb_8, mb_9) in the external memory 102, and the entropy coding circuit 150 reads the intermediate data INFO from the external memory 102 when needed.

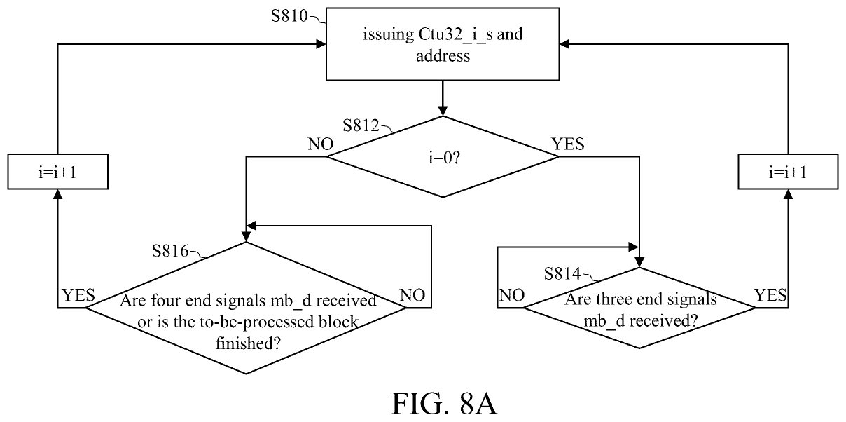

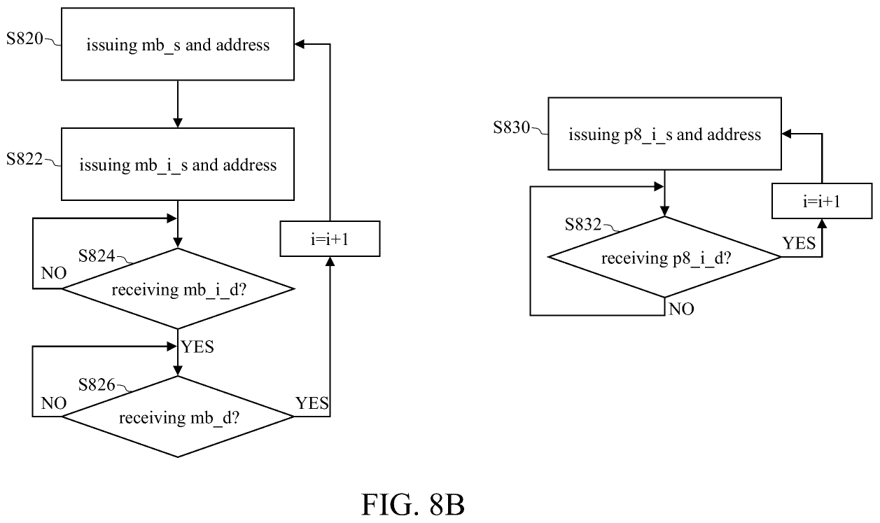

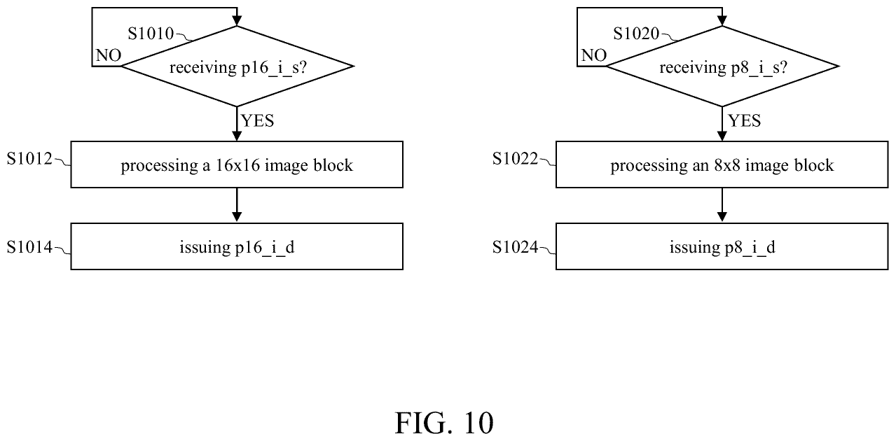

In the following, the operational details of the control circuit 110 and the mode decision circuit 135 are discussed with reference to FIGS. 8A, 8B, and 10.

Reference is made to FIGS. 8A and 8B, which are the flowcharts illustrating the generation of start signals by the control circuit 110 in the second video encoding mode. That is, FIGS. 8A and 8B show the control method of the video encoder 101, which includes the following steps.

Step S810: The control circuit 110 issues a start signal Ctu32_i_s and an address. For example, the control circuit 110 issues the start signal Ctu32_0_s and address of the to-be-processed block Ctu32_0 at the time point t1 in FIG. 7. The control circuit 110 may issue the address and the first start signal of a frame (e.g., a start signal corresponding to a to-be-processed block at the upper left corner of a frame, that is, the start signal Ctu32_0_s of the to-be-processed block Ctu32_0 in FIG. 7) according to the frame start signal Fm_s.

Step S812: The control circuit 110 determines whether the start signal Ctu32_i_s that has just been issued is the first start signal of a frame (i.e., determining whether i is equal to 0). If YES, then the flow proceeds to step S814; if NO, then the flow proceeds to step S816.

Step S814: After receiving three end signals mb_d, the control circuit 110 returns to step S810 to issue the next start signal Ctu32_i_s. In the example of FIG. 7, the three end signals mb_d may correspond to the time points t8, t1l, and t14, respectively. After receiving the third end signal mb_d, the control circuit 110 issues the next start signal Ctu32_i_s (e.g., the start signal Ctu32_1_s around the time point t14) to control the data loading circuit 130 to load the next to-be-processed block (e.g., the to-be-processed block Ctu32_1). That is to say, when the coding blocks mb_0, mb_1, and mb_2 are processed, the data loading circuit 130 reads the to-be-processed block Ctu32_1.

Step S816: Starting from the second start signal Ctu32_i_s (i>0), each time the control circuit 110 receives four end signals mb_d or after finishing processing the to-be-processed block, the control circuit 110 issues the next start signal Ctu32_i_s (i.e., return to step S810). For example, as shown in FIG. 7, the control circuit 110 issues the start signal Ctu32_2_s of the to-be-processed block Ctu32_2 after receiving the four end signals mb_d corresponding to the coding blocks mb_3 to mb_6, and issues the start signal Ctu32_3_s of the to-be-processed block Ctu32_3 after finishing processing the coding blocks mb_7, mb_8, and mb_9.

As shown in FIG. 7 and FIG. 8A, at the time point t14 (when the control circuit 110 generates the start signal Ctu32_1_s), the mode decision circuit 135 has not yet finished processing the to-be-processed block Ctu32_0 (since the coding block mb_4 has not yet been processed). That is to say, the control circuit 110 generates the start signal Ctu32_1_s of the to-be-processed block Ctu32_1 before the mode decision circuit 135 finishes processing the to-be-processed block Ctu32_0.

Reference is made to FIG. 8B. Steps S820, S822, S824, and S826 correspond to steps S520, S522, S524, and S526 in FIG. 5A, respectively, wherein the uses of the start signal mb_s, the start signal mb_i_s, the end signal mb_i_d, and the end signal mb_d may correspond to those of the start signal Ctu_s, the start signal p32_i_s, the end signal p32_i_d, and the end signal Ctu_d, respectively. For the sake of brevity, redundant discussion is omitted here. After receiving the start signal mb_i_s, the entropy coding circuit 150 performs the preprocessing task(s) for encoding a coding block mb_i, which include(s), but are not limited to, resetting parameters and/or registers.

Reference is made to FIG. 7 and the steps S830 and S832 in FIG. 8B. For a coding block mb_i, the control circuit 110 processes its four 8×8 image blocks in a “Z-order curve” sequence (as indicated by the dashed arrows in FIG. 7). That is to say, after receiving an end signal p8_i_d of an image block (step S832 is YES), the control circuit 110 issues the start signal p8_i_s of the next image block (step S830) (e.g., the time points t4 to t6 in FIG. 7).

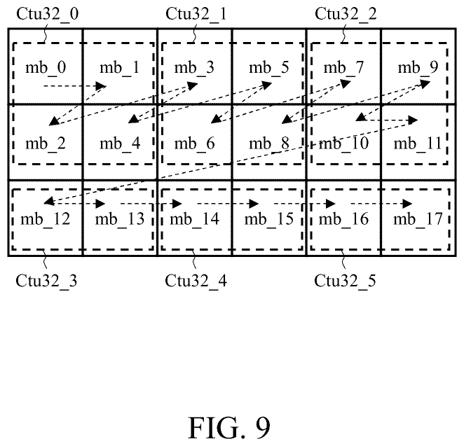

Reference is made to FIG. 9, which is a schematic diagram of multiple image blocks in the second video encoding mode according to another embodiment of the present invention. The width of the frame shown in FIG. 7 is an odd multiple of 16 (where the width of the to-be-processed block Ctu32_2_i_s 16 pixels), while the width of the frame shown in FIG. 9 is an even multiple of 16 (where the width of the to-be-processed block Ctu32_2_i_s 32 pixels). The mode decision circuit 135 processes the coding blocks in the order from lower to higher numbers (as indicated by the dashed arrows). It should be noted that, for the frame shown in FIG. 9, the mode decision circuit 135 does not immediately process the coding block mb_10 after processing the coding block mb_8; instead, it processes the remaining coding blocks of the to-be-processed block Ctu32_2 in this order. mb_9, mb_10, and mb_11.

FIG. 10 is a flowchart illustrating the generation of the end signal p16_i_d (or p8_i_d) by the mode decision circuit 135 according to the start signal p16_i_s (or p8_i_s) in the second video encoding mode. Steps S1010 (S1020), S1012 (S1022), and S1014 (S1024) are similar to steps S610, S612, and S614 in FIG. 6A, respectively. For the sake of brevity, repeated discussion is omitted here.

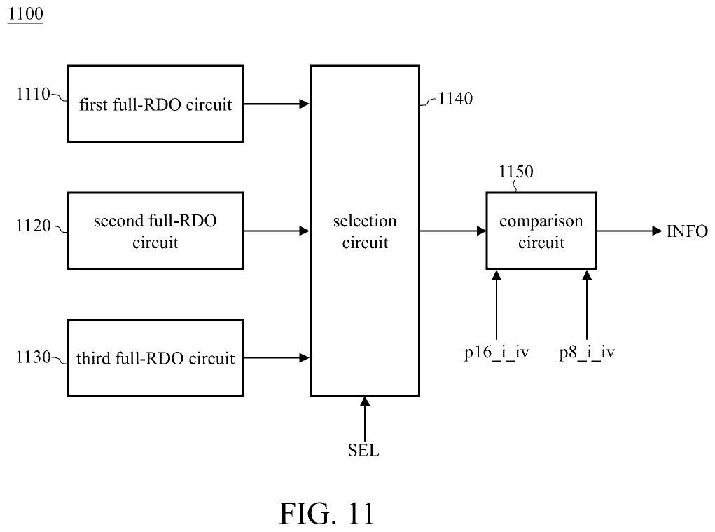

Reference is made to FIG. 11, which is a functional block diagram of the mode prediction circuit of the mode decision circuit 135 according to the present invention. The mode prediction circuit 1100 includes a first full-RDO circuit 1110, a second full-RDO circuit 1120, a third full-RDO circuit 1130, a selection circuit 1140, and a comparison circuit 1150. The first full-RDO circuit 1110, the second full-RDO circuit 1120, and the third full-RDO circuit 1130 may correspond to H.265, AV1, and H.264, respectively. The selection circuit 1140 selects one of the three circuits according to the mode selection signal SEL which may be issued by the control circuit 110. After comparing the results of the full-RDO operations, the comparison circuit 1150 outputs the intermediate data INFO. The full-RDO algorithm and the generation of the intermediate data based on the results of the full-RDO operations is well known to people having ordinary skill in the art, and the details are omitted for brevity.

Continuing with FIG. 11. When the video encoder 101 operates in the first video encoding mode, the comparison circuit 1150 further outputs the intermediate data INFO according to the indication signal p16_i_iv and/or the indication signal p8_i_iv. More specifically, when the indication signal p16_i_iv and/or the indication signal p8_i_iv indicates that the corresponding image block is absent, the comparison circuit 1150 does not select the absent image block (i.e., the entropy coding circuit 150 only encodes the image blocks that exist).

As discussed above, the present invention addresses missing or absent image blocks in the first video encoding mode (FIGS. 4 to 6C) and encodes each coding block mb_i in a diagonal sequence (as indicated by the dashed arrows in FIG. 7) in the second video encoding mode (FIGS. 7 to 10). Consequently, the control circuit 110 can manage the various components of the video encoder 101 using a similar process across the first and second video encoding modes. This allows for a significant degree of component sharing of the video encoder 101 between both video encoding modes, leading to cost savings.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A video encoder coupled to an external memory and configured to encode an input data to generate an output data, wherein the input data comprises a coding block, the video encoder comprising:
a control circuit configured to generate a start signal corresponding to the coding block;
a data loading circuit coupled to the control circuit and configured to read the coding block from the external memory according to the start signal;
a mode decision circuit coupled to the control circuit and configured to process the coding block according to the start signal and generate an intermediate data; and
an entropy coding circuit coupled to the mode decision circuit and configured to generate the output data according to the intermediate data;
wherein in a video encoding mode, the control circuit further generates an indication signal indicating whether an image block of the coding block exists, and the mode decision circuit processes the image block according to the indication signal.

2. The video encoder of claim 1, wherein the coding block is located at a right boundary of a frame.

3. The video encoder of claim 1, wherein the coding block is N by N pixels in size, the image block is N/2 by N/2 pixels or N/4 by N/4 pixels in size, and N is four or an integer multiple of four.

4. The video encoder of claim 3, wherein N is 32, and the video encoding mode is High Efficiency Video Coding (H.265) or Alliance for Open Media (AOMedia) Video 1 (AV1).

5. The video encoder of claim 1, wherein the image block is a first image block, the mode decision circuit processes a second image block before processing the first image block, when the indication signal is a preset value, the mode decision circuit outputs a second block coding method of the second image block to be used as a first block coding method of the first image block.

6. The video encoder of claim 5, wherein the start signal is a first start signal, the control circuit further generates a second start signal corresponding to the first image block, the mode decision circuit outputs the second block coding method after waiting for a preset time in response to the second start signal.

7. The video encoder of claim 6, wherein the mode decision circuit generates an end signal after finishing processing the second image block, and the control circuit generates the second start signal according to the end signal.

8. The video encoder of claim 5, wherein the preset value is a first preset value, when the indication signal is a second preset value, the mode decision circuit processes the first image block to generate the first block coding method of the first image block, and the first preset value is different from the second preset value.

9. A video encoder coupled to an external memory and configured to encode an input data to generate an output data, wherein the input data comprises a first to-be-processed block and a second to-be-processed block, the video encoder comprising:
a control circuit configured to generate a first start signal corresponding to the first to-be-processed block and a second start signal corresponding to the second to-be-processed block;
a data loading circuit coupled to the control circuit and configured to read the first to-be-processed block from the external memory according to the first start signal and read the second to-be-processed block from the external memory according to the second start signal;
a mode decision circuit coupled to the control circuit and configured to process the first to-be-processed block according to the first start signal, process the second to-be-processed block according to the second start signal, and generate an intermediate data; and
an entropy coding circuit coupled to the mode decision circuit and configured to generate the output data according to the intermediate data;
wherein the first to-be-processed block is adjacent to the second to-be-processed block, and in a video encoding mode, the control circuit generates the second start signal before the mode decision circuit finishes processing the first to-be-processed block.

10. The video encoder of claim 9, wherein the first to-be-processed block is N by N pixels in size, the second to-be-processed block is N by N pixels in size, and N is four or an integer multiple of four.

11. The video encoder of claim 10, wherein the first to-be-processed block comprises a first coding block, a second coding block, a third coding block, and a fourth coding block, the first coding block, the second coding block, the third coding block, and the fourth coding block are all N/2 by N/2 pixels in size, the mode decision circuit sequentially processes the first coding block, the second coding block, the third coding block, and the fourth coding block, and the control circuit generates the second start signal when the mode decision circuit finishes processing the third coding block.

12. The video encoder of claim 11, wherein the second to-be-processed block comprises a fifth coding block, the fifth coding block is N/2 by N/2 pixels in size, the mode decision circuit processes the fifth coding block after finishing processing the third coding block and processes the fourth coding block after finishing processing the fifth coding block.

13. The video encoder of claim 12, wherein the fifth coding block is located at upper right of the fourth coding block.

14. The video encoder of claim 12, wherein the second to-be-processed block further comprises a sixth coding block that is adjacent to the fifth coding block but not adjacent to the fourth coding block, and the mode decision circuit processes the sixth coding block after finishing processing the fourth coding block.

15. The video encoder of claim 10, wherein N is 32, and the video encoding mode is MPEG-4 Part 10 Advanced Video Coding (H.264).

16. A video encoder coupled to an external memory and configured to encode an input data to generate an output data, wherein the input data comprises a first block and a second block, and the first block is adjacent to the second block, the video encoder comprising:
a control circuit configured to generate a first start signal corresponding to the first block and a second start signal corresponding to the second block;
a data loading circuit coupled to the control circuit and configured to read the first block from the external memory according to the first start signal and read the second block from the external memory according to the second start signal;
a mode decision circuit coupled to the control circuit and configured to process the first block according to the first start signal, process the second block according to the second start signal, and generate an intermediate data; and
an entropy coding circuit coupled to the mode decision circuit and configured to generate the output data according to the intermediate data;
wherein in a first video encoding mode, the control circuit generates the second start signal after the mode decision circuit finishes processing the first block; in a second video encoding mode, the control circuit generates the second start signal before the mode decision circuit finishes processing the first block;
wherein the first block and the second block are both N by N pixels in size, and N is four or an integer multiple of four.

17. The video encoder of claim 16, wherein the first video encoding mode is High Efficiency Video Coding (H.265) or Alliance for Open Media (AOMedia) Video 1 (AV1), and the second video encoding mode is MPEG-4 Part 10 Advanced Video Coding (H.264).

18. The video encoder of claim 17, wherein N is 32.

19. The video encoder of claim 17, wherein the second block is located at a right boundary of a frame, and in the first video encoding mode, the control circuit further generates an indication signal indicating whether an image block of the second block exists, and the mode decision circuit processes the image block according to the indication signal.

20. The video encoder of claim 17, wherein in the second video encoding mode, the first block comprises a first coding block, a second coding block, a third coding block, and a fourth coding block, the first coding block, the second coding block, the third coding block, and the fourth coding block are all N/2 by N/2 pixels in size, the mode decision circuit sequentially processes the first coding block, the second coding block, the third coding block, and the fourth coding block, and the control circuit generates the second start signal when the mode decision circuit finishes processing the third coding block.
